(19) United States
(12) Patent Application Publication
(10) Pub. No.: US 2016/0329071 A1
(43) Pub. Date: Nov. 10, 2016

(54) Variable Rough Lap Machining For Magnetic Recording Read-Write Heads

(71) Applicant: HGST Netherlands B.V., Amsterdam (NL)

(72) Inventors: Jacey R. Beaucage, San Jose, CA (US); Richard C. Campbell, Morgan Hill, CA (US); Glenn P. Gee, San Jose, CA (US); Unal Murat Guruz, San Jose, CA (US); Trevor W. Olson, San Jose, CA (US); Scott Thomas, San Jose, CA (US)

(21) Appl. No.: 14/707,674

(22) Filed: May 8, 2015

(51) Int. Cl. G11B 5/60; B24B 37/04

(52) U.S. Cl. CPC G11B 5/6005; B24B 37/048

(57) ABSTRACT

A process for machining a row of magnetic read-write head sliders involves setting, for the row of sliders, (a) a wedge angle that corresponds to an angle relative to the direction of the reader-writer offset (e.g., the y-axis) and (b) a read-write error correction process control that corresponds to a machining profile according to which the row is machined along the direction of the row (e.g., the x-axis). The row of sliders is then machined simultaneously according to the set wedge angle and the set read-write error correction control process, effectively providing multiple-axis machining control for varying reader and writer dimensional control along a row. Thus, a slider at one end of the row may be machined at a different angle, relative to the x-axis, than a slider at the opposite end of the row.

### FIELD OF EMBODIMENTS

Embodiments of the invention may relate generally to hard disk drives and more particularly to an approach to machining magnetic recording read-write heads.

### BACKGROUND

A hard-disk drive (HDD) is a non-volatile storage device that is housed in a protective enclosure and stores digitally encoded data on at least one circular disk having magnetic surfaces. When an HDD is in operation, each magnetic-recording disk is rapidly rotated by a spindle system. Data is read from and written to a magnetic-recording disk using a read-write head that is positioned over a specific location of a disk by an actuator. A read-write head uses a magnetic field to read data from and write data to the surface of a magnetic-recording disk. A write head makes use of the electricity flowing through a coil, which produces a magnetic field. Electrical pulses are sent to the write head, with different patterns of positive and negative currents. The current in the coil of the write head induces a magnetic field across the gap between the head and the magnetic disk, which in turn magnetizes a small area on the recording medium.

High volume magnetic thin film head slider fabrication involves high precision subtractive machining performed in discrete material removal steps. Slider processing starts with a completed thin film head wafer consisting of 40,000 or more devices, and is completed when all the devices are individuated and meet numerous and stringent specifications. The individual devices ultimately become read-write heads, for example Perpendicular Magnetic Recording (PMR) heads, flying over a spinning disk. The heights at which read-write heads fly over the disk are ever decreasing, to increase the amount of information that can be stored on a disk in a given area, i.e., the areal density.

Precise control of the read head dimensions (using resistance) and of the write head dimensions, by way of lapping and machining, are commonly practiced and are a necessity of manufacturing. Of increasing importance is the alignment of the read and write portions of the head relative to each other and the disk they will ultimately fly over. For optimum yield, performance and stability, precise dimensional control over both the reader and writer elements is desirable.

Any approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF EMBODIMENTS

Embodiments of the invention are generally directed toward a process or method for machining a row of magnetic read-write head sliders, a read-write head slider prepared according to such a process, and a hard disk drive comprising a read-write head slider prepared according to such a process. The machining process involves setting, for the row (or “row-bar”) of sliders, (a) a wedge angle that corresponds to an angle relative to the direction of the reader-writer offset (e.g., the y-axis) and (b) a read-write error correction process control that corresponds to a machining profile according to which the row is machined along the direction of the row (e.g., the x-axis). For example, the machining profile may vary linearly along the row. The row of sliders is then machined simultaneously according to the set wedge angle and the set read-write error correction control process, effectively providing multiple-axis machining control for varying reader and writer dimensional control along a row-bar. Thus, a slider at one end of the row may be machined at a different angle, relative to the x-axis, than a slider at the opposite end of the row, for example.

Embodiments discussed in the Summary of Embodiments section are not meant to suggest, describe, or teach all the embodiments discussed herein. Thus, embodiments of the invention may contain additional or different features than those discussed in this section. Furthermore, no limitation, element, property, feature, advantage, attribute, or the like expressed in this section, which is not expressly recited in a claim, limits the scope of any claim in any way.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a plan view illustrating a hard disk drive (HDD), according to an embodiment;

FIG. 2 is an exploded perspective view illustrating a wafer of head sliders in various stages of processing, according to an embodiment;

FIG. 2A is a perspective view illustrating a read-write transducer, according to an embodiment;

FIG. 3 is a diagram illustrating a wedge angle lapping process, according to an embodiment;

FIG. 4 is a flow diagram illustrating a head slider fabrication process, according to an embodiment;

FIG. 5 is a perspective view illustrating a block of head sliders, according to an embodiment;

FIG. 6 is a flow diagram illustrating a method for machining a row of head sliders, according to an embodiment; and

FIG. 7 is a set of views illustrating a read-write head slider, according to an embodiment.

### DETAILED DESCRIPTION

Approaches to machining a row of magnetic read-write head sliders are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### Physical Description of Illustrative Operating Environments

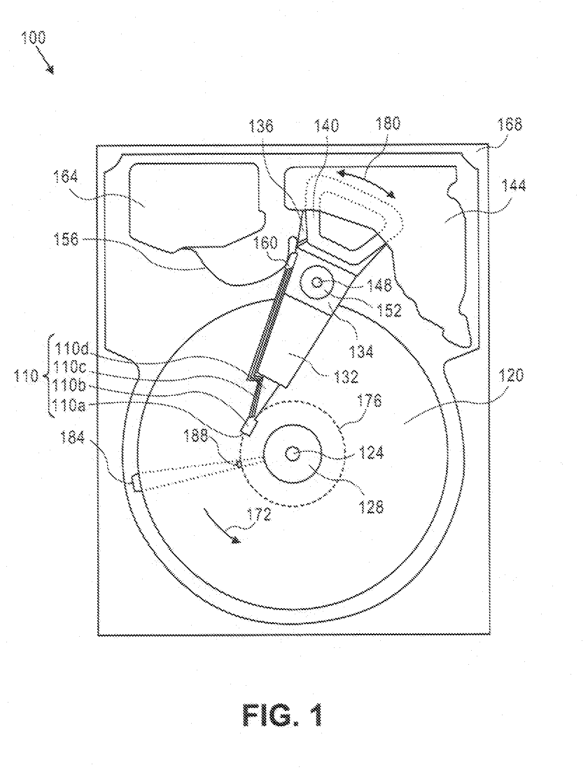

Embodiments may be used in the context of machining a row of magnetic read-write head sliders, such as for use in a hard disk drive (HDD) storage device. Thus, in accordance with an embodiment, a plan view illustrating an HDD 100 is shown in FIG. 1 to illustrate an exemplary operating environment.

FIG. 1 illustrates the functional arrangement of components of the HDD 100 including a slider 110b that includes a magnetic read-write head 110a. Collectively, slider 110b and head 110a may be referred to as a head slider. The HDD 100 includes at least one head gimbal assembly (HGA) 110 including the head slider, a lead suspension 110c attached to the head slider typically via a flexure, and a load beam 110d attached to the lead suspension 110c. The HDD 100 also includes at least one magnetic-recording medium 120 rotatably mounted on a spindle 124 and a drive motor (not visible) attached to the spindle 124 for rotating the medium 120. The read-write head 110a, which may also be referred to as a transducer, includes a write element and a read element for respectively writing and reading information stored on the medium 120 of the HDD 100. The medium 120 or a plurality of disk media may be affixed to the spindle 124 with a disk clamp 128.

The HDD 100 further includes an arm 132 attached to the HGA 110, a carriage 134, a voice-coil motor (VCM) that includes an armature 136 including a voice coil 140 attached to the carriage 134 and a stator 144 including a voice-coil magnet (not visible). The armature 136 of the VCM is attached to the carriage 134 and is configured to move the arm 132 and the HGA 110, to access portions of the medium 120, being mounted on a pivot-shaft 148 with an interposed pivot bearing assembly 152. In the case of an HDD having multiple disks, the carriage 134 is called an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM) to which the actuator arm is coupled, may be collectively referred to as a head stack assembly (HSA). An HSA may, however, include more or fewer components than those described. For example, an HSA may refer to an assembly that further includes electrical interconnection components. Generally, an HSA is the assembly configured to move the head slider to access portions of the medium 120 for read and write operations.

With further reference to FIG. 1, electrical signals (e.g., current to the voice coil 140 of the VCM) comprising a write signal to and a read signal from the head 110a, are provided by a flexible interconnect cable 156 (“flex cable”). Interconnection between the flex cable 156 and the head 110a may be provided by an arm-electronics (AE) module 160, which may have an on-board pre-amplifier for the read signal, as well as other read-channel and write-channel electronic components. The AE 160 may be attached to the carriage 134 as shown. The flex cable 156 is coupled to an electrical-connector block 164, which provides electrical communication through electrical feedthroughs provided by an HDD housing 168. The HDD housing 168, also referred to as a base, in conjunction with an HDD cover provides a sealed, protective enclosure for the information storage components of the HDD 100.

Other electronic components, including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the medium 120 that is affixed to the spindle 124. As a result, the medium 120 spins in a direction 172. The spinning medium 120 creates a cushion of air that acts as an air-bearing on which the air-bearing surface (ABS) of the slider 110b rides so that the slider 110b flies above the surface of the medium 120 without making contact with a thin magnetic-recording layer in which information is recorded.

The electrical signal provided to the voice coil 140 of the VCM enables the head 110a of the HGA 110 to access a track 176 on which information is recorded. Thus, the armature 136 of the VCM swings through an arc 180, which enables the head 110a of the HGA 110 to access various tracks on the medium 120. Information is stored on the medium 120 in a plurality of radially nested tracks arranged in sectors on the medium 120, such as sector 184. Correspondingly, each track is composed of a plurality of sectored track portions (or “track sector”), for example, sectored track portion 188. Each sectored track portion 188 may be composed of recorded data and a header containing a servo-burst-signal pattern, for example, an ABCD-servo-burst-signal pattern, which is information that identifies the track 176, and error correction code information. In accessing the track 176, the read element of the head 110a of the HGA 110 reads the servo-burst-signal pattern which provides a position-error-signal (PES) to the servo electronics, which controls the electrical signal provided to the voice coil 140 of the VCM, enabling the head 110a to follow the track 176. Upon finding the track 176 and identifying a particular sectored track portion 188, the head 110a either reads data from the track 176 or writes data to the track 176 depending on instructions received by the disk controller from an external agent, for example, a microprocessor of a computer system.

An HDD's electronic architecture comprises numerous electronic components for performing their respective functions for operation of an HDD, such as a hard disk controller (“HDC”), an interface controller, an arm electronics module, a data channel, a motor driver, a servo processor, buffer memory, etc. Two or more of such components may be combined on a single integrated circuit board referred to as a “system on a chip” (“SOC”). Several, if not all, of such electronic components are typically arranged on a printed circuit board that is coupled to the bottom side of an HDD, such as to HDD housing 168.

References herein to a hard disk drive, such as HDD 100 illustrated and described in reference to FIG. 1, may encompass a data storage device that is at times referred to as a “hybrid drive”. A hybrid drive refers generally to a storage device having functionality of both a traditional HDD (see, e.g., HDD 100) combined with solid-state storage device (SSD) using non-volatile memory, such as flash or other solid-state (e.g., integrated circuits) memory, which is electrically erasable and programmable. As operation, management and control of the different types of storage media typically differs, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O intensive data, and the like. Further, a hybrid drive may be architected and configured essentially as two storage devices in a single enclosure, i.e., a traditional HDD and an SSD, with either one or multiple interfaces for host connection.

### Introduction

As mentioned, high volume magnetic thin film head slider fabrication involves high precision subtractive machining performed in discrete material removal steps. Slider processing starts with a completed thin film head wafer consisting of 40,000 or more devices, and is completed when all the devices are individuated and meet numerous and stringent specifications. The individual devices ultimately become read-write heads. Therefore, precise control of the read head dimension and of the alignment of the read and write portions of the head relative to each other are critical components of the read-write head fabrication process, in order to achieve optimum yield, performance and stability. In order to achieve ideal dimensions for each individual read-write head, one might choose to process each head slider individually. However, that approach is hardly feasible from a practical manufacturability standpoint because, for example, it results in a significantly more complex, inefficient and costly head slider fabrication process.

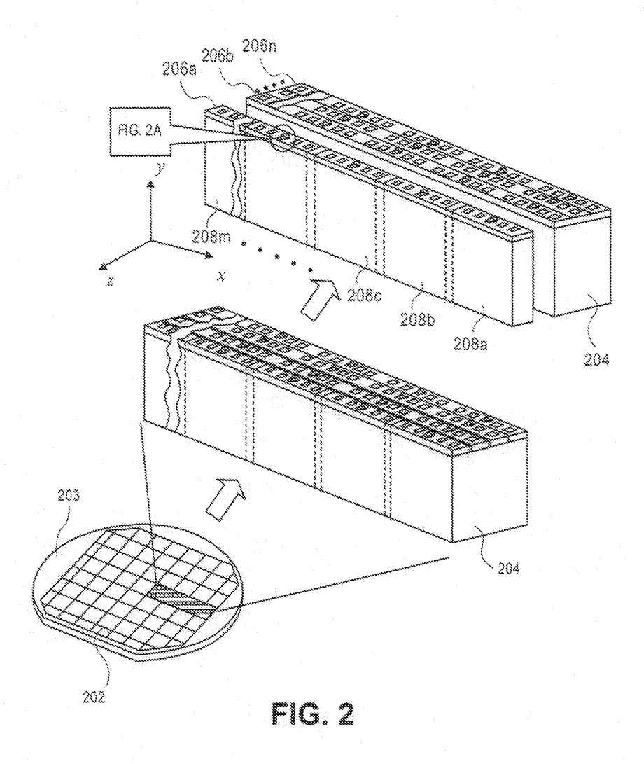

FIG. 2 is an exploded perspective view illustrating a wafer of head sliders in various stages of processing, and FIG. 2A is a perspective view illustrating a read-write transducer, both according to an embodiment. FIG. 2 depicts a wafer 202, comprising a matrix of unfinished head sliders having unfinished read-write transducers (see, e.g., FIG. 2A) deposited on a substrate 203, for which AlTiC is commonly used. The matrix of sliders is typically processed in batches, i.e., subsets of the wafer, historically referred to as “quads” and now at times referred to as “chunks” or “blocks”. A block of unfinished head sliders, block 204, comprises multiple rows 206a-206n (or “row-bars”) of unfinished head sliders, where n represents a number of row-bars per block 204 that may vary from implementation to implementation. Each row 206a-206n comprises multiple head sliders 208a-208m, where m represents a number of head sliders per row 206a-206n that may vary from implementation to implementation.

With reference to FIG. 2A, read-write transducer 210 comprises a writer 212 and a corresponding coil 216. Write heads make use of the electricity flowing through a coil such as coil 216 to produce a magnetic field. Electrical pulses are sent to the write head, with different patterns of positive and negative currents, where the current in the coil of the write head induces a magnetic field across the gap between the head and the magnetic disk, which in turn magnetizes a small area on the recording medium. A writer such as writer 212 has a corresponding flare point 213, which is the distance between (a) the end of the main pole (i.e., the end of the pole tip 220) of the writer and (b) the point 221 at which the pole tip 220 flares down to its smallest cross-section. The flare point 213 is commonly considered a critical dimension associated with a magnetic writer such as writer 212.

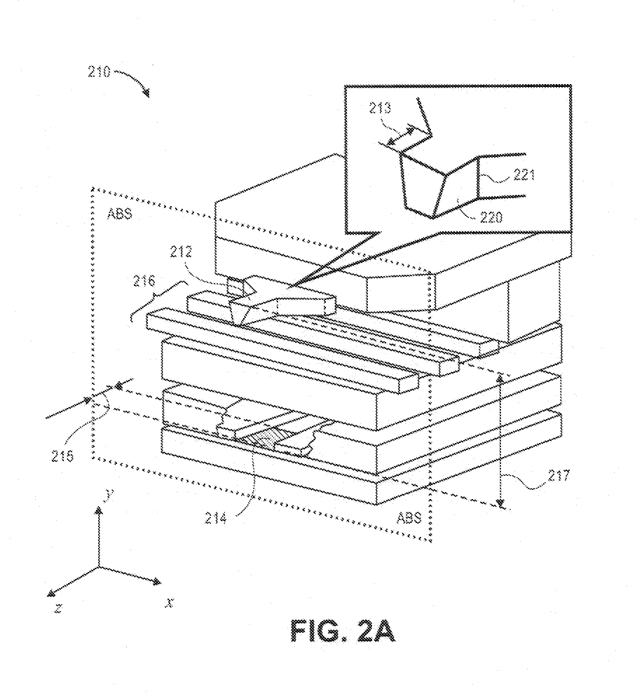

Continuing with FIG. 2A, read-write transducer 210 further comprises a reader 214 having a corresponding stripe height 215, which is also considered a critical dimension associated with a magnetic reader such as reader 214. The flare point 213 of the writer 212 and the stripe height 215 of the reader 214 are commonly controlled in fabrication by a process referred to as wedge angle lapping (“WAL”), which is described in more detail herein (such as in reference to FIG. 3).

Read-write transducers such as transducer 210 are further associated with a reader-writer offset 217, which is the distance between a certain point or surface of the reader 214 and a certain point or surface of the writer 212, in what is depicted as the y-direction. The offset 217 is designed into the read-write transducer 210. However, a “rotational” (or angular) offset between the writer 212 and the reader 214 may occur during wafer 202 fabrication, which may cause a linear and/or angular offset which may vary along a row in what is depicted as the x-direction. This rotational offset is largely due to the fact that the writer 212 and the reader 214 are deposited in different thin-film layers and is therefore due to manufacturing process limitations. For example, the writer 212 and the reader 214 may not always line up precisely relative to the air bearing surface and/or relative to each other because of the challenges associated with exposing different masks having different patterns at different deposition layers, in nanometer-scale manufacturing processes.

### Head Slider Fabrication Processes

A typical head slider fabrication process flow may include the following: a wafer (e.g., wafer 202 of FIG. 2) fabrication process, which includes deposition of the reader and writer elements (e.g., reader 214 and writer 212 of FIG. 2A), followed by block (or “quad”) slicing to remove a block (e.g., block 204 of FIG. 2) of unfinished sliders from the wafer. An outer row (e.g., row 206a of FIG. 2) of sliders (e.g., head sliders 208a-208m of FIG. 2) from the block may then be rough lapped (e.g., wedge angle lapped) in order to fabricate the desired reader and writer dimensions (e.g., flare point 213 and stripe height 215 of FIG. 2A), and then the outer rough-lapped row (e.g., row 206a) sliced from the block (e.g., block 204). From there, the row may be further lapped, such as “back-lapped” to form the flexure-side surface opposing the air bearing surface (ABS), and “ABS fine-lapped” to further refine the ABS surface. This then may lead to overcoating, and rail etching, etc. of the ABS surface to form the final air bearing or flying surface, at which point each head slider (e.g., head sliders 208a-208m) may be diced or parted from the row to individuate each finished head slider, whereby it can then be coupled with a flexure, assembled into a head-gimbal assembly (HGA), and so on.

### Wedge Angle Lapping

As discussed, the flare point 213 (FIG. 2A) of the writer 212 (FIG. 2A) and the stripe height 215 (FIG. 2A) of the reader 214 (FIG. 2A) are commonly controlled in fabrication by a process referred to as wedge angle lapping (“WAL”). With WAL (also referred to as “rough lapping”), the lapping is generally directed to the reader while the writer is left uncontrolled. That is, the final reader 214 stripe height 215 is targeted where the lapping of the reader 214 often relies on resistance-based feedback (e.g., from use of an electronic lapping guide, or “ELG”), while the final writer 212 flare point 213 is dependent thereon.

FIG. 3 is a diagram illustrating a wedge angle lapping process, according to an embodiment. The left-hand diagram of FIG. 3 depicts a head slider 302 before air bearing surface (“ABS”) rough lapping. The reader 214 and corresponding desired stripe height 215 are depicted, the lapping of which as previously mentioned is typically controlled via a resistance-based feedback mechanism, and the writer 212 and corresponding resultant flare point 213 are also depicted. A dashed line illustrates the desired final ABS, which is achieved by lapping the ABS side of the head slider 302 at a wedge angle 303.

Thus, with reference to the right-hand side diagram of FIG. 3, ABS lapping may be performed on head slider 302 using a lapping fixture 304 and a lapping plate 306 (e.g., commonly diamond-encrusted and/or accompanied by a diamond slurry), depicted in simplified form. The fixture 304 is set such that the lapping plate 306 operates to lap the head slider 302 at a wedge angle 303 until the proper reader 214 and writer 212 dimensions are ultimately reached, thereby achieving the final ABS that produces at least the desired stripe height 215 for this particular portion of the head slider fabrication process.

Wedge angle lapping is typically performed at a certain predetermined wedge angle on an entire row-bar of sliders, such as any of row 206a-206n (FIG. 2). Thus, each of the sliders 208a-208m within a given row is rough lapped at the same wedge angle, such as wedge angle 303 (FIG. 3). However, as previously mentioned, a “rotational” (or angular) offset between the writer 212 (FIG. 2A) and the reader 214 (FIG. 2A) may occur during wafer 202 (FIG. 2) fabrication, which may cause a linear and/or angular offset in what is depicted as the x-direction. For example, the writer 214 and/or reader 212 may be fabricated at an angle to the ABS plane, which would be the x-y plane as depicted in FIG. 2A, rather than precisely perpendicular to the ABS/x-y plane. Furthermore, such a rotational offset corresponding to the writer 212 and the reader 214 may not be constant along the length (x-direction) of any given row (e.g., row 206a) of head sliders, nor across multiple rows (e.g., rows 206a-206n) from a block (e.g., block 204 of FIG. 2). Again, therein lies a reason that processing of head sliders individually, if practically feasible, may be considered desirable.

### Variable Rough Lap Machining

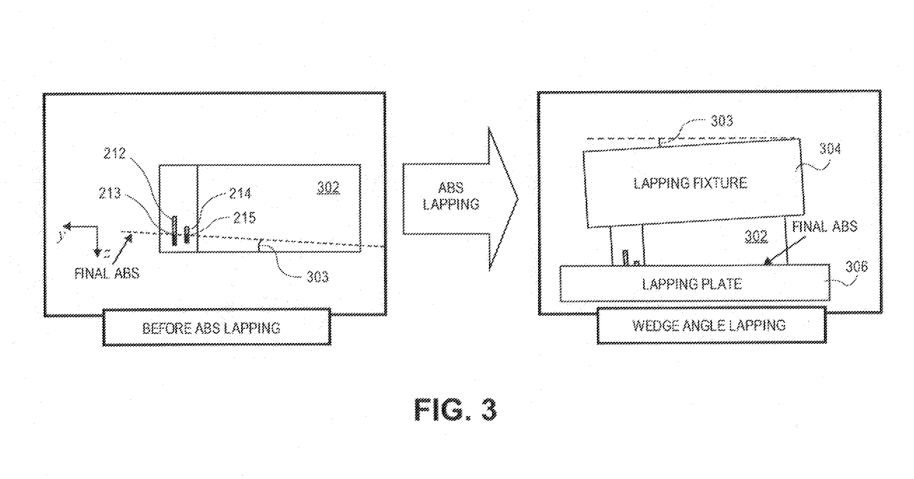

FIG. 4 is a flow diagram illustrating a head slider fabrication process, according to an embodiment. The process depicted in FIG. 4 is comprised of a series of processes, shown as 402, 404, 406, 408. The head slider fabrication process comprises a “row slice” 402 process, which slices one row of sliders from the block (e.g., row 206a of FIG. 2) while beginning formation of the air bearing surface of the next row of sliders (e.g., row 206b of FIG. 2). Then, a “rough lapping” 404 process is performed on that next row (e.g., row 206b), which redefines the air bearing surface by removing slider material. This rough lapping 404 process is, according to an embodiment, the point at which the wedge angle lapping is performed.

Subsequently, a “backlap” 406 process is performed (similar to the aforementioned wafer fabrication process), during which the flexure-side surface opposing the air bearing surface is formed. After that, a “fine lapping” 408 process is performed, during which the air bearing surface is further defined in a finer manner, before eventually etching the various aerodynamic and other features onto the final flyable air bearing surface.

Recall the aforementioned wafer fabrication process, in which deposition of the reader and writer elements was followed by block slicing to remove a block of unfinished sliders from the wafer, which was followed by an outer row of sliders from the block undergoing rough lapping (e.g., wedge angle lapping), while still part of the block, in order to fabricate the desired reader and writer dimensions. Continuing, the outer rough lapped row was then sliced from the block, from which the row was further lapped via back-lapping and ABS fine-lapping, and then coated, etched, etc., at which point each head slider was diced from the row. Notably, a row of sliders was rough-lapped while still constituent to the block, and then the row was sliced from the block and further lapped and processed.

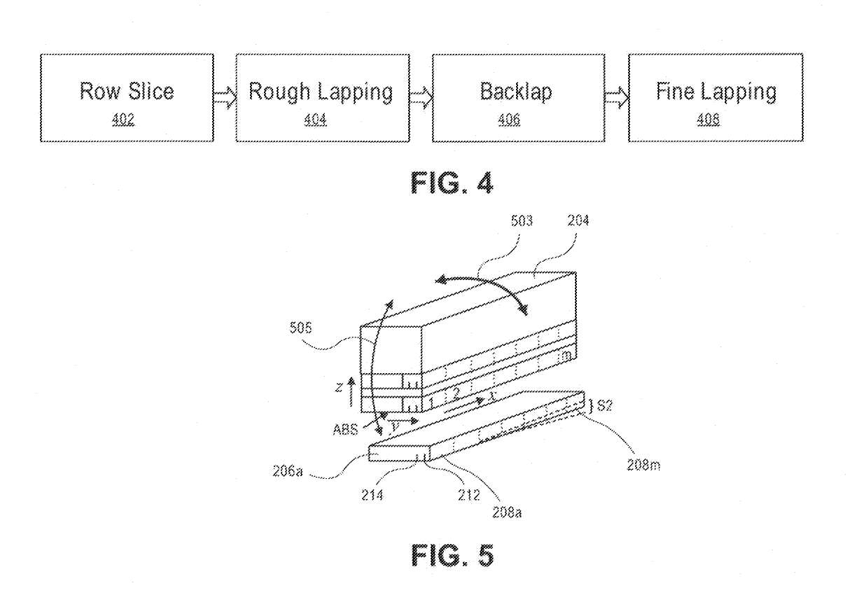

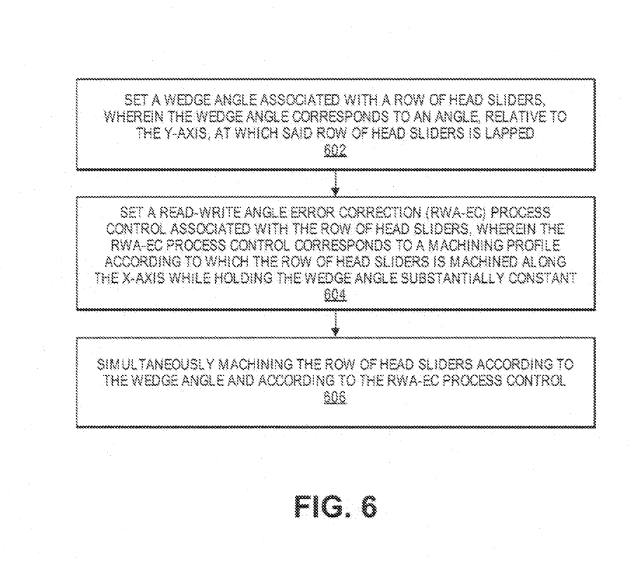

By contrast and according to an embodiment, the row slice 402 process associated with one row of sliders and the rough lapping 404 process associated with the next row of sliders are both essentially performed simultaneously, and in a manner in which the machining process may vary along a given row of head sliders, e.g., for the next row of sliders, as is described in more detail in reference to FIG. 6 and with reference to FIG. 5.

### Method for Machining a Row of Magnetic Read-Write Head Sliders

FIG. 6 is a flow diagram illustrating a method for machining a row of head sliders, according to an embodiment. FIG. 5 is a perspective view illustrating a block of head sliders, according to an embodiment. Each head slider in the row comprises a reader and a writer, such as reader 214 (FIG. 2A and FIG. 5) and writer 212 (FIG. 2A and FIG. 5). Further, the row of head sliders has an x-axis defined as along the direction of the row (see, e.g., FIG. 2 and FIG. 5), and a y-axis defined along a direction of a reader-writer offset associated with the head sliders within the row (see, e.g., FIG. 2, the reader-writer offset 217 of FIG. 2A, and FIG. 5).

At block 602, a wedge angle associated with the row of head sliders is set, wherein the wedge angle corresponds to an angle, relative to the y-axis, at which the row of sliders is lapped (or, generally, machined). For example, a wedge angle, from the y-axis and generally within the y-z plane, such as angle 303 (FIG. 3) is set on/in/for a machining tool such as a grinder. According to an embodiment, the wedge angle is set for a grinder machine, in contrast with a lapping plate. As previously described, the wedge angle is set to achieve a desired reader 214 stripe height 215 (FIG. 2) and writer 212 flare point 213 (FIG. 2). With reference to FIG. 5, the wedge angle corresponds to direction of rotation in the y-z plane consistent with rotation arrow 503.

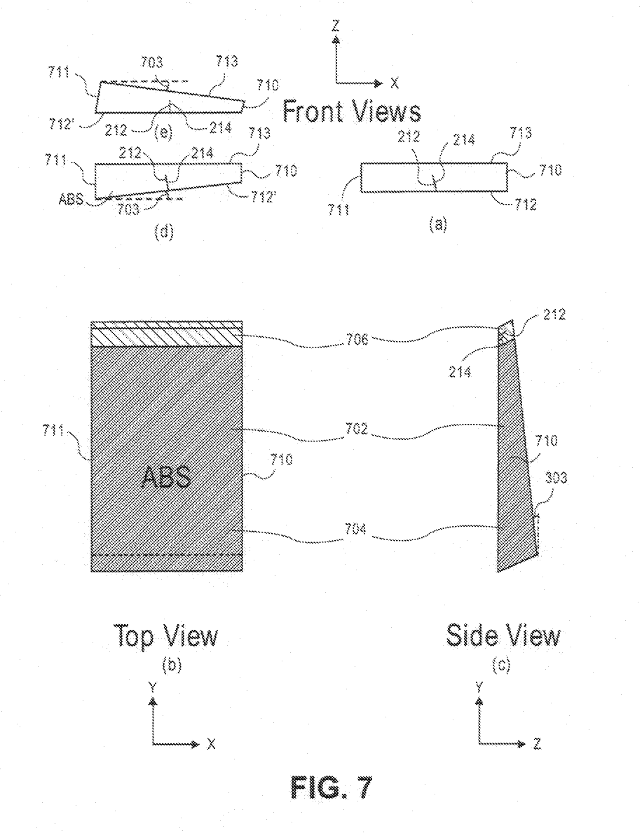

At block 604, a read-write angle error correction (“RWA-EC”) process control associated with the row of head sliders is set, wherein the RWA-EC process control corresponds to a machining profile according to which the row of head sliders is machined along the x-axis while holding the wedge angle substantially constant. The machining profile represents the physical profile, or path, along which an operator desires to machine the row of head sliders along the x-axis, for example, to achieve an angle such as angle 703 (FIG. 7) for a particular head slider. For example, at block 604 the RWA-EC process control is set on/in/for a machining tool such as the grinder used to set the wedge angle at block 602.

Furthermore, this machining profile characterizes the manner in which the series of ABS surfaces of the sliders (e.g., head sliders 208a-208m of FIG. 2) within and along the row (e.g., row 206b of FIG. 2) are machined, while parting the previously processed row (e.g., row 206a of FIG. 2) from the block 204 (FIG. 2). Recall that the head sliders within a given row of a wafer, and across the rows of a wafer, are likely to experience various differing rotational or angular reader-writer offsets due to manufacturing limitations. Thus, for a non-limiting example, the RWA-EC process control may be used to compensate for such rotational offsets within a row of head sliders. With reference to FIG. 5, the RWA-EC process control corresponds to a direction of rotation within the x-z plane consistent with rotation arrow 505.

Note that the order of setting the wedge angle at block 602 followed by setting the RWA-EC process control at block 604 is simply a non-limiting example, and the order in which such actions are performed may vary from implementation to implementation. For example, the RWA-EC process control may be set first and followed by setting the wedge angle, and still fall within the scope of and the practice of the embodiments described and claimed herein.

At block 606, the row of head sliders is simultaneously machined according to the wedge angle set at block 602 and according to the RWA-EC process control set at block 604. For example, the machining according to the set wedge angle corresponds to controlling a dimension associated with the reader, and the machining according to the set RWA-EC process control corresponds to controlling the angle(s) of the reader and of the writer relative to the x-axis. According to an embodiment, the machining process referenced in block 606 is performed using a grinding wheel. Further, according to a related embodiment, the machining process referenced in block 606 is performed using a cup wheel.

Thus, with reference to FIG. 5, the machined profile of the series of head slider air bearing surfaces constituent to a row of head sliders, i.e., along the x-axis, may be antiparallel to the opposing head slider surfaces, i.e., the flexure-side surfaces. Such variability in the machined air bearing surfaces of the row of head sliders is generally characterized in FIG. 5 by the various dashed lines labeled “S2”, depicting that various ABS profiles may be formed by utilizing the method described in reference to FIG. 6 which, in effect, provides for variable multi-axis rough lapping/machining control over a row of head sliders. Thus, according to an embodiment, the step of machining referenced at block 606 includes machining the row of head sliders such that a first head slider constituent to the row is machined at a different angle relative to the x-axis than a last head slider constituent to that row. For example, the air bearing surface of head slider 208a (e.g., FIG. 5) may be machined at a different angle, relative to the x-axis, than the air bearing surface of head slider 208m (e.g., FIG. 5). Again, this stems from the variability of the machining along the x-axis that can be employed by way of the RWA-EC process control feature which, with reference to FIG. 5, corresponds to a direction of rotation within the x-z plane consistent with rotation arrow 505.

Regarding the RWA-EC process control and the corresponding machining profile for which such control is set to achieve, in the context of implementation with a machining tool, according to an embodiment the RWA-EC process control may be characterized at least by (1) a feed rate and (2) an angle change rate, which together correspond to achieving the desired machining profile. The feed rate corresponds to the rate at which the machining process is performed along the x-axis, and the angle change rate corresponds to the rate at which the machining angle relative to the x-axis is changed while machining is performed along the x-axis. Further, other machine operational parameters may be used to control the row-bar x-axis machining profile, based on the operational capabilities of a given machining tool.

The manner in which a machining tool is configured or programmed, or the like, in order for it to be able to operate in accordance with a RWA-EC process may vary from implementation to implementation. For a non-limiting example, an operator may input one or more specific feed rate and one or more specific angle change rate into a machining tool in order to reach or at least approximate a desired machining profile. For another non-limiting example, an operator may input a machining profile, characterized for example (a) by a linear and/or quadratic equation, (b) by a set of points from which an equation (e.g., a “best fit”) may be computed, or simply (c) by a start point and an end point relative to the x-z plane, or the like, where the input data may be derived from parameters associated with the particular wafer being processed, such as the reader-writer rotational offset at various locations along a row of sliders.

FIG. 7 is a set of views illustrating a read-write head slider, according to an embodiment. FIG. 7 includes (a) a front view of an unprocessed head slider, (b) a top view of a processed head slider, (c) a side view of a processed head slider, (d) a front view of a processed head slider, and (e) a front view of the processed head slider of view (d) rotated clockwise slightly. Views (b), (c), and (d) are largely orthographic projections of a head slider processed according to the method described in reference to FIG. 6, however these views are not intended to be “true” or entirely accurate projections as some features, lines, phantom lines, etc. may be omitted for sake of clarity. Furthermore, the features, lines, angles, and the like, of these views are not intended to be drawn to scale, as some may be exaggerated for purposes of clarity and explanation.

The side view (c) depicts the wedge angle 303 (see also FIG. 3), relative to the y-axis, at which the head slider is machined. As discussed, this part of the machining process is typically for obtaining a desired stripe height 215 (FIG. 2A) of the reader 214 (FIG. 2A) along with a desired flare point 213 (FIG. 2A) of the writer 212 (FIG. 2A).

The front view (a) depicts an unprocessed head slider having a rotational, or angular, offset of the writer 212 and the reader 214. Both element lead lines point to the same location because for simplicity of explanation and illustration, both the writer 212 and the reader 214 are assumed to have an equivalent rotational offset in the x-z plane and are depicted as anti-perpendicular to the bottom (ABS) surface 712. However, in practice this would not always be the case. As mentioned, due in part to the fact that the writer 212 and the reader 214 are deposited in different thin-film layers, using different masks, each of the writer 212 and the reader 214 may be fabricated having differing rotational angles relative to the surface 712, whereby the RWA-EC process control could still be utilized to compensate and compromise to some degree.

To compensate for the reader-writer angular offset utilizing the read-write angle error correction (RWA-EC) process control as described herein, the ABS surface of the head slider depicted is machined at an angle to the x-axis. Thus, as depicted in front view (d), the lower ABS surface 712 (view (a)) is machined at an angle 703 from the x-axis to produce the machined ABS surface 712′. The opposing flexure-side surface 713 is shown as unlapped in view (d). To provide a visual illustration of how an x-axis angled machining of the surface 712 to produce machined surface 712′ might be used to compensate for the writer 212 and/or reader 214 initially having a rotational offset from the surface 712, front view (e) depicts the head slider rotated clockwise a bit, i.e., rotated clockwise an amount equal to angle 703, such that the machined surface 712′ is now flat or parallel to what would be a disk rotating thereunder. With the machined surface 712′ now shown parallel to a virtual disk surface, it can be seen that the writer 212 and reader 214 are now more closely perpendicular to the lower ABS surface 712′, which is a more desirable configuration than the configuration depicted in view (a).

According to an embodiment and as generally depicted in front view (e), side surface 710, which adjoins the machined ABS surface 712′ and the opposing flexure-side surface 713, is at an obtuse angle to the machined surface 712′ because of the angle 703 at which the surface 712 was machined to produce the machined surface 712′. Likewise, if machined otherwise, side surface 711 adjoining the machined surface 712′ and the surface 713 may be at an obtuse angle to one or the other surfaces 712′, 713. Furthermore, and according to an embodiment, the machined surface 712′ is antiparallel to the opposing flexure-side surface 713, again because of the angle 703 at which the surface 712 was machined to produce the machined surface 712′. However, an operator may choose to perform a backlap 406 process (FIG. 4) on the flexure-side surface 713 (FIG. 7(e)) in order to obtain a parallel between the flexure-side surface 713 and the machined ABS surface 712′, prior to mounting the finished head slider on a flexure/HGA.

### Extensions and Alternatives

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps, and are not intended to specify or require a particular order of carrying out such steps.

What is claimed is:

1. A method for machining a row of magnetic read-write head sliders wherein each head slider comprises a reader and a writer, wherein said row has an x-axis along the direction of the row and a y-axis along the direction of a reader-writer offset associated with said head sliders in said row, the method comprising:
setting a wedge angle associated with said row, wherein said wedge angle corresponds to an angle, relative to the y-axis, at which said row of head sliders is lapped;
setting a read-write angle error correction (RWA-EC) process control associated with said row, wherein said RWA-EC process control corresponds to a machining profile according to which said row of head sliders is machined along the x-axis while holding said wedge angle substantially constant; and
simultaneously machining said row of head sliders according to said wedge angle and according to said RWA-EC process control.

2. The method of claim 1, wherein said machining comprises machining said row such that a first head slider constituent to said row is machined at a different angle relative to the x-axis than a last head slider constituent to said row.

3. The method of claim 1, wherein said RWA-EC process control is characterized at least by a feed rate and an angle change rate corresponding to achieving said machining profile, wherein said feed rate corresponds to a rate at which said machining is performed along said x-axis and said angle change rate corresponds to a rate at which a machining angle relative to said x-axis is changed while machining is performed along said x-axis.

4. The method of claim 1, wherein machining according to said wedge angle corresponds to controlling one or more dimension associated with said reader and machining according to said RWA-EC process control corresponds to controlling the angles of said reader and said writer relative to the x-axis.

5. The method of claim 1, wherein said machining is performed on a first surface of said row of head sliders, said method further comprising, after simultaneously machining said row:
lapping a second surface of said row opposing said first surface;
fine lapping said first surface of said row; and
dicing said row into individual head sliders.

6. The method of claim 1, wherein said machining is performed using a grinding wheel.

7. The method of claim 6, wherein said machining is performed using a grinding cup wheel.

8. A magnetic read-write head slider prepared from a row of magnetic read-write head sliders wherein each head slider comprises a reader and a writer, wherein said row has an x-axis along the direction of the row and a y-axis along the direction of a reader-writer offset associated with said head sliders in said row, said read-write head slider prepared by a process comprising:
setting a wedge angle associated with said row, wherein said wedge angle corresponds to an angle relative to the y-axis;
setting a read-write angle error correction (RWA-EC) process control associated with said row; and
simultaneously machining a first surface of said row of head sliders according to said wedge angle and according to said RWA-EC process control.

9. The read-write head slider of claim 8, comprising:
a second surface of said row opposing said first surface;
a third surface adjoining said first and second surfaces, wherein said first surface is at an obtuse angle to said third surface.

10. The read-write head slider of claim 8, wherein said first surface is antiparallel to said second surface.

11. The read-write head slider of claim 8, wherein said machining according to said wedge angle corresponds to controlling one or more dimension associated with said reader and said machining according to said RWA-EC process control corresponds to controlling the angles of said reader and said writer relative to the x-axis.

12. The read-write head slider of claim 8, wherein said machining is performed using a grinding wheel.

13. The read-write head slider of claim 8, said process further comprising:
lapping a second surface of said row opposing said first surface;
fine lapping said first surface of said row; and
dicing said row into individual head sliders.

14. A hard disk drive comprising:
one or more recording disk medium rotatably mounted on a spindle;
a read-write head slider comprising a read-write transducer configured to read from and to write to at least one of said one or more disk medium;
a voice coil actuator configured to move said head slider to access portions of said at least one disk medium;
wherein read-write head slider is prepared from a row of magnetic read-write head sliders wherein each head slider comprises a reader and a writer, wherein said row has an x-axis along the direction of the row and a y-axis along the direction of a reader-writer offset associated with said head sliders in said row, said read-write head slider prepared by a process comprising:
setting a wedge angle associated with said row, wherein said wedge angle corresponds to an angle, relative to the y-axis, at which said row of head sliders is lapped,
setting a read-write angle error correction (RWA-EC) process control associated with said row, wherein said RWA-EC process control corresponds to a machining profile according to which said row of head sliders is machined along the x-axis while holding said wedge angle substantially constant,
simultaneously machining a first surface of said row of head sliders according to said wedge angle and according to said RWA-EC process control,
lapping a second surface of said row opposing said first surface,
fine lapping said first surface of said row, and
dicing said row into individual head sliders.

15. The hard disk drive of claim 14, wherein said read-write head slider comprises a third surface adjoining said first and second surfaces of said read-write head slider, wherein said first surface of said read-write head slider is at an obtuse angle to said third surface of said read-write head slider.

16. The hard disk drive of claim 14, wherein said first surface of said read-write head slider is antiparallel to said second surface of said read-write head slider.

17. The hard disk drive of claim 14, wherein in said process said machining according to said wedge angle corresponds to controlling one or more dimension associated with said reader and said machining according to said RWA-EC process control corresponds to controlling the angles of said reader and said writer relative to the x-axis.
